(19) United States
(12) Patent Application Publication
(10) Pub. No.: US 2010/0139635 A1
(43) Pub. Date: Jun. 10, 2010

(54) Progressive Nitrous Oxide Controller

(76) Inventor: Kent Carroll, Bolingbrook, IL (US)

Correspondence Address: THORPE NORTH & WESTERN, LLP., P.O. Box 1219, SANDY, UT, 84091-1219, US

(21) Appl. No.: 12/331,609

(22) Filed: Dec. 10, 2008

(51) Int. Cl. F02M 25/10; F02B 23/00

(52) U.S. Cl. 123/585

(57) ABSTRACT

A progressive nitrous oxide system for an engine includes a nitrous oxide supply to supply a flow of nitrous oxide, a nitrous oxide valve operatively coupled to the nitrous oxide supply to open and close to start and stop the flow of nitrous oxide, a nitrous oxide nozzle operatively coupled to the nitrous oxide valve to supply the flow of nitrous oxide to the engine, and means operatively coupled between the valve and the nozzle for initially reducing the flow of nitrous oxide and progressively increasing the flow of nitrous oxide from a reduced amount to a greater amount over a time period. The means can include a valve member movable with respect to a flow channel by pressure of the flow of nitrous oxide, and a fluid reservoir including an orifice and configured to receive fluid displaceable through the orifice.

### RELATED APPLICATIONS

This application is related to U.S. Pat. No. 7,451,751; U.S. patent application Ser. No. 12/251,051, filed Oct. 14, 2008; U.S. patent application Ser. No. 12/250,928; filed Oct. 14, 2008; U.S. patent application Ser. No. 12/251,121, filed Oct. 14, 2008; and U.S. patent application Ser. No. ______, filed Dec. 10, 2008 (as TNW Docket Number 00051-35174.CIP); which are herein incorporated by reference.

### BACKGROUND

1. Field of the Invention

The present invention relates generally to nitrous oxide systems (NOS) for vehicle engines. More particularly, the present invention relates to a progressive nitrous oxide controller.

2. Related Art

Nitrous oxide (N₂O) injection systems and chargers for vehicles are designed to temporarily boost the power output of internal combustion engines. Such systems inject vaporized nitrous oxide into the combustion chamber of an engine during the intake stroke of the piston to provide more oxygen for combustion than would otherwise be available during normal operation. The additional oxygen in the combustion chamber allows extra fuel to also be injected into the combustion chamber. The combined increase in fuel and oxygen results in a more energetic combustion stroke, with greater power being transferred back to the piston and drive shaft with an ultimate increase in the horsepower output of the engine. Such nitrous oxide systems can include a solenoid valve or the like to release nitrous oxide from pressurized bottle into the engine. The sudden addition of nitrous oxide and fuel can be hard on the engine, transmission and power transfer components.

### SUMMARY OF THE INVENTION

It has been recognized that it would be advantageous to develop a nitrous oxide controller to slowly introduce the nitrous to the engine.

The invention provides a progressive nitrous oxide controller device with a nitrous oxide flow channel disposable between a nitrous oxide source and an engine and through which a flow of nitrous oxide is flowable. A valve member is movable with respect to the flow channel by pressure of the flow of nitrous oxide to enlarge a portion of the flow channel to increase the flow of nitrous oxide through the flow channel. Resisting means is operatively coupled to the valve member for resisting movement of the valve member and enlargement of the portion of the flow channel. Therefore, the pressure of the flow of nitrous oxide must move the valve member, under resistance from the resistance means, to enlarge the portion of the flow channel and increase the flow of nitrous oxide.

In accordance with a more detailed aspect of the present invention, the valve member can have an initial restricted position corresponding to a reduced size of the portion of the flow channel configured to initially restrict the flow of nitrous oxide through the flow channel; and one more subsequent less restricted positions corresponding to progressively enlarged sizes of the portion of the flow channel configured to progressively increase the flow of nitrous oxide through the flow channel. The pressure of the flow of nitrous oxide causes the valve member to progress from the initial restricted position through the subsequent less restricted positions while the resisting means resists movement of the valve member.

In accordance with a more detailed aspect of the present invention, the resisting means can include a fluid reservoir including an orifice and configured to receive fluid displaceable through the orifice.

In addition, the invention provides a progressive nitrous oxide controller device with a body having a nitrous oxide channel extending between a nitrous oxide inlet and a nitrous oxide outlet. The nitrous oxide channel receives a flow of nitrous oxide. A nitrous oxide valve member is movably disposed in the body with respect to the nitrous oxide channel to enlarge and reduce a portion of the nitrous oxide channel to respectively increase and decrease the flow of nitrous oxide through the channel. A resistance piston is coupled to the nitrous oxide valve member and movably disposed in the body, and moves under pressure from the flow of nitrous oxide to enlarge the portion of the nitrous oxide channel and increase the flow of nitrous oxide. A resistance cylinder is in the body with the resistance piston movably disposed therein. An incompressible fluid is disposed in the resistance cylinder. An orifice is associated with the resistance cylinder through which the incompressible fluid can pass. The resistance piston acts to force the incompressible fluid through the orifice under pressure of the nitrous oxide.

Furthermore, the invention provides a progressive nitrous oxide system for an engine including a nitrous oxide supply to supply a flow of nitrous oxide, and a nitrous oxide valve operatively coupled to the nitrous oxide supply to open and close to start and stop the flow of nitrous oxide. A nitrous oxide nozzle is operatively coupled to the nitrous oxide valve and to supply the flow of nitrous oxide to the engine. The system further includes means operatively coupled between the valve and the nozzle for initially reducing the flow of nitrous oxide and progressively increasing the flow of nitrous oxide from a reduced amount to a greater.

In accordance with a more detailed aspect of the present invention, the amount can increase over a time period of between approximately 1 to 5 seconds.

### BRIEF DESCRIPTION OF THE DRAWINGS

Additional features and advantages of the invention will be apparent from the detailed description which follows, taken in conjunction with the accompanying drawings, which together illustrate, by way of example, features of the invention; and, wherein:

FIG. 1a is a cross-sectional side view of a progressive nitrous oxide controller in accordance with an embodiment of the present invention, shown in a closed or more restricted configuration;

FIG. 1b is a cross-sectional side view of the nitrous oxide controller of FIG. 1, shown in a more open or unrestricted configuration;

FIG. 2 is a schematic view of a nitrous oxide system in accordance with an embodiment of the present invention with the nitrous oxide controller of FIG. 1;

FIGS. 3a-3d are cross-sectional side views of the progressive nitrous oxide controller of FIG. 1, shown in various stages of operation;

FIG. 4 is a schematic graph of nitrous oxide flow versus time for the controller of FIG. 1; and

FIG. 5 is an exploded perspective view of the progressive nitrous oxide controller of FIG. 1.

Reference will now be made to the exemplary embodiments illustrated, and specific language will be used herein to describe the same. It will nevertheless be understood that no limitation of the scope of the invention is thereby intended.

### DETAILED DESCRIPTION OF EXAMPLE EMBODIMENT(S)

The following detailed description of the invention makes reference to the accompanying drawings, which form a part thereof and in which are shown, by way of illustration, exemplary embodiments in which the invention may be practiced. While these exemplary embodiments are described in sufficient detail to enable those skilled in the art to practice the invention, it should be understood that other embodiments may be realized and that various changes to the invention may be made without departing from the spirit and scope of the present invention. As such, the following more detailed description of the exemplary embodiments of the present invention is not intended to limit the scope of the invention as it is claimed, but is presented for purposes of illustration only: to describe the features and characteristics of the present invention, and to sufficiently enable one skilled in the art to practice the invention. Accordingly, the scope of the present invention is to be defined solely by the appended claims.

The present invention describes a system and method for implementing a nitrous oxide injection system. The embodiments of the present invention described herein generally provide for selectively increasing the performance of an internal combustion engine (such as gasoline, diesel, liquid petroleum or compressed natural gas fueled) and/or providing a power boost to such an engine. Snowmobiles, All-Terrain Vehicles (ATVs), motorcycles, automobiles, semi-trucks, riding lawnmowers and tractors are examples of vehicles that can benefit from the use of nitrous oxide systems.

The nitrous oxide system can include a pressurized nitrous oxide source, such as a pressure vessel or bottle filled with compressed nitrous oxide liquid. A nitrous oxide flow line can deliver the pressurized nitrous oxide from the source to an injection nozzle, which can inject the nitrous oxide into an intake of the engine where the nitrous oxide can combine with the intake air for mixing with the vehicle fuel. A control valve can regulate the flow of pressurized fluid through the nitrous oxide flow line. The system can further include a supplemental fuel line that can be coupled to a primary fuel line extending between a tank and intake of the engine. Alternatively, the supplemental fuel line can be coupled directly to the tank or a secondary tank. The supplemental fuel line can provide a secondary source of fuel, in addition to the fuel from the primary fuel line, to the engine when nitrous oxide is also being delivered to the engine via the nitrous oxide flow line. The nitrous oxide can be injected to the intake side of the engine. For instance, it may be beneficial to inject the nitrous oxide into an air box or engine intake prior to the carburetor, to allow more time for complete mixing between the nitrous oxide and the intake air and to allow the evaporating nitrous oxide to further cool the intake air before passing into the carburetor. In another aspect of the present invention, it may also be beneficial to direct the additional fuel directly into the carburetor, or downstream of the carburetor, depending upon physical access to the intake system. In any event, the nitrous oxide can be injected on the intake side of the engine.

In one exemplary embodiment of the present invention, a progressive nitrous oxide controller can be coupled in the nitrous oxide flow line to slow the flow of nitrous oxide, or to progressively increase the flow of nitrous oxide, to the nozzle and engine. Slowing or progressively increasing the nitrous oxide flow, as opposed to instantly delivering the entire maximum flow to the engine, resists abrupt stress or torque on the engine, transmission and/or power train; thus resisting damage and prolonging life.

The above-recited advantages will be apparent in light of the detailed description set forth below and best understood with reference to the accompanying drawings, wherein the elements and features of the invention are designated by numerals throughout. These advantages are not meant to be limiting in any way. Indeed, one skilled in the art will appreciate that other advantages may be realized, other than those specifically recited herein, upon practicing the present invention.

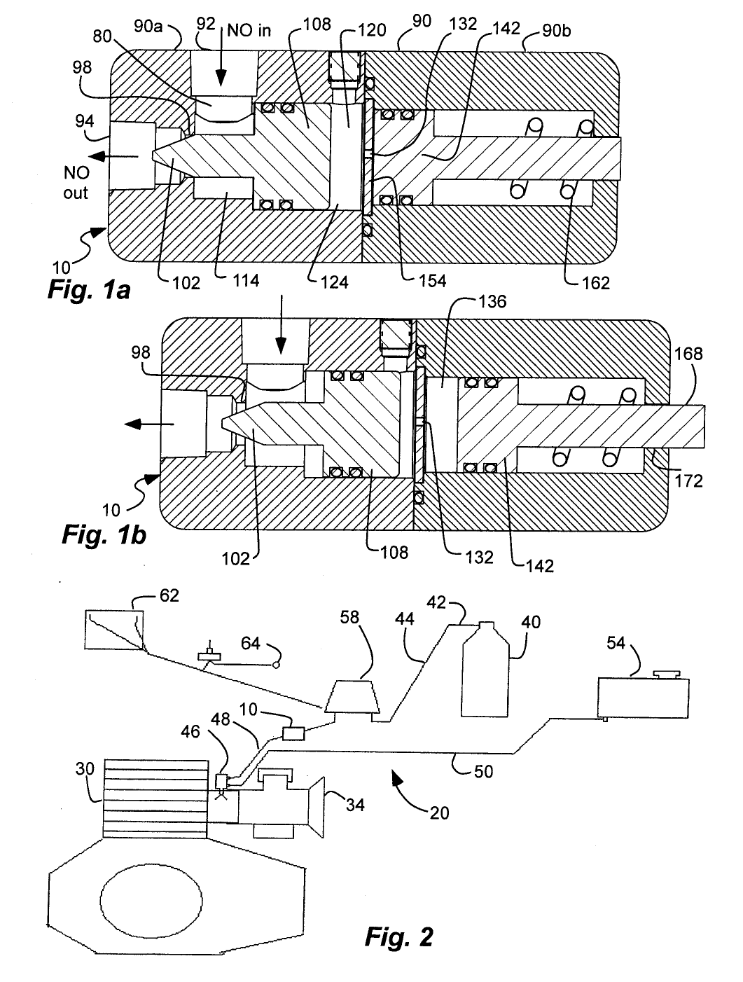

As illustrated in FIGS. 1a-2, a progressive nitrous oxide controller, indicated generally at 10, in an example implementation in accordance with the invention is shown with a nitrous oxide system, indicated generally at 20, for providing nitrous oxide to an engine 30. The engine can be an internal combustion engine and can be associated with a vehicle and its components, such as a transmission and power train. The engine can include an air intake 34, and a carburetor or fuel injection system.

Illustrated in FIG. 2 is a schematic view of the exemplary embodiment of the nitrous oxide injection system 20 coupled to an engine 30. A nitrous oxide source, such as a nitrous oxide bottle 40, contains pressurized nitrous oxide, such as compressed nitrous oxide liquid. The nitrous oxide bottle 40 can be mounted within or on the structure of the vehicle. If the vehicle is a car or truck, the bottle can be installed a protected enclosure, such as the engine compartment, passenger compartment or trunk. If the vehicle is of a type without large enclosures, such as an ATV or motorcycle or snowmobile, the bottle can also be attached to structures such as a bulkhead, belly pan, hood, side panels steering column and the like. It will be appreciated that the nitrous oxide bottle can be mounted anywhere there is sufficient space, and where the bottle will not interfere with engine operation.

The bottle can be coupled to the proximal end 42 of a nitrous oxide flow line 44. The term “line” is used broadly herein to refer to any device that can deliver a fluid from a source to a destination. For example, a line can be a hollow tube, a channel, a hose, a pipe, a path, and the like. An injection nozzle 46 can be coupled to the distal end 48 of the nitrous oxide flow line. The term “nozzle” is also used broadly herein to refer to means for delivering the nitrous oxide from the nitrous oxide flow line to the engine intake. For example, the nozzle can be a nozzle, an opening in the nitrous oxide flow line, a port, a valve, and the like. In addition, the nozzle 46 can be a nitrous oxide injector or nozzle to inject both nitrous oxide and fuel as described in U.S. patent application Ser. No. 12/250,928, filed Oct. 14, 2008; which is herein incorporated by reference. As discussed above, the nozzle 46 can be disposed on the air intake side of the engine, prior to or subsequent to the air intake, carburetor and/or fuel injector. The nozzle can be disposed at an engine intake such as an air box, carburetor inlet, or carburetor outlet allows the nitrous oxide to be injected into the engine. In the present invention, the nitrous oxide can be combined with the intake air prior to being drawn into the carburetor or fuel injector, and mixed with the fuel according to the settings of the carburetor or fuel injector. Alternatively, the nitrous oxide can be introduced into the engine after the fuel is mixed by placing the nozzle downstream from the carburetor. And in yet another aspect of the present invention, the nitrous oxide injection nozzle can be coupled to head of the power cylinder for direct injection in the combustion chamber.

An in-line nitrous oxide pressure regulator can be coupled to the flow line 44. Such a pressure regulator is described in U.S. Pat. No. 7,451,751; which is herein incorporated by reference. The pressure regulator can regulate the pressure of the nitrous oxide from the bottle pressure, such as 800 psi, to less than 600 psi in one aspect, or less than 300 psi in another aspect.

A supplemental fuel line 50 can be tapped into the engine's primary fuel line or directly to the fuel tank 54 to provide a secondary source of fuel from the fuel tank. Alternatively, the supplemental fuel line can be coupled to a primary fuel line or to an auxiliary fuel tank. A supplemental fuel valve can be coupled to the supplemental fuel line to control flow of fuel through the fuel line and into the engine inlet. Alternatively, an electronic fuel injection (EFI) system can be used to increase the fuel associated with the added nitrous oxide. Various fuel delivery options as described in U.S. Pat. No. 7,451,751; which is herein incorporated by reference. The nitrous oxide injection nozzle and the outlet from the supplemental fuel line can be directed to the same location in the engine inlet, or to different locations. As described above, the nozzle 46 can be a nitrous oxide injector or nozzle to inject both nitrous oxide and fuel. Thus, the supplemental fuel line 50 can be coupled to the nozzle 46 or nitrous oxide injector.

A control valve or nitrous oxide valve 58 can be coupled to the nitrous oxide flow line 44 to control the flow of pressurized nitrous oxide from the nitrous oxide bottle to the injection nozzle. In one aspect of the invention, the control valve can be a solenoid valve. In other aspects the control valve 58 can also be a flow control valve, a gate valve, a ball valve, a pilot valve, a proportional valve, a globe valve, a check valve, a needle valve, and a stopcock valve, etc. A battery power source 62 (or other vehicle electrical source) can be electrically coupled to the control valve 58, and a control switch 64 can be operatively coupled to the control valve or battery power source to activate the control valve. The control switch 64 can be mounted on the vehicle, such as by a throttle, to be actuated by a user. Thus, when the user actuates the control switch 64, the control valve 58 opens and allows pressurized nitrous oxide to flow from the bottle to the nozzle. It will be appreciated that the control valve 58 can generally have two positions, namely open and closed. Thus, when the control switch 64 is activated, the valve operates from closed to open, delivering the entire nitrous oxide flow through the flow line 44.

Referring again to FIGS. 1a-2, the progressive nitrous oxide controller 10 can be coupled to the nitrous oxide line 44 downstream of the control valve 50, or between the control valve 50 and the engine 30. The progressive nitrous oxide controller 10 can slow the flow of nitrous oxide, or can progressively increase the flow of nitrous oxide from no flow, or a lesser flow, to a greater flow. The controller 10 can have a closed, or more closed, initial configuration and can initially slow the flow of nitrous oxide, and can progressively open over a predetermined time period (such as 1-5 seconds) so that the flow of nitrous oxide to the engine starts at a lesser amount, and progressively increased to a greater amount so that the strain or torque on the engine, transmission and/or power train is gradual, rather than abrupt.

The progressive nitrous oxide controller 10 includes a nitrous oxide flow channel 80 that is fluidly coupled to the nitrous oxide flow line 44 between the nitrous oxide source or bottle 40 and the engine. The controller 10 can include a housing or body 90 defining the channel 80 or through which the channel passes. The body 90 can include a pair of body halves 90a and 90b coupled together. The channel 80 can be formed in a first body half 90a with a nitrous oxide inlet 92 coupled to the nitrous oxide source and a nitrous oxide outlet 94 coupled to the engine. A portion of the flow channel, such as a bore or hole 98, can be disposed intermediate the inlet and outlet and can be enlarged or reduced, or opened and closed, as described in greater detail below. The inlet 92 and the outlet 94 can be orthogonal or transversely oriented with respect to one another. The hole 98 can be aligned with and/or parallel with the outlet 94. An annular perimeter flange, or valve seat, can surround and define the hole 98. The body halves 90a and 90b can be formed of metal and can be mechanically fastened together, such as by bolts. The flow channel 80 and the hole 98 can be machined in the first body half.

A valve member 102 can be movable with respect to the flow channel 80 to enlarge the portion of the flow channel and increase the flow of nitrous oxide through the flow channel. The valve member 102 can have a pointed or needle shape that moves into and out of the hole 98 to initially close or restrict the flow of nitrous oxide when in the hole, and open the flow when out of the hole. Thus, the size of the hole 98 is defined by the annular perimeter flange and the position of the valve member in therein. The valve member 102 has an initial restricted position, shown in FIG. 1a, corresponding to a reduced size of the hole 98 or portion of the flow channel to initially restrict the flow of nitrous oxide. The valve member 102 has a plurality of subsequent less restricted positions, as shown in FIG. 1b, corresponding to progressively enlarged sizes of the hole 98 or portion of the channel. The valve member 102 is movable by pressure of the flow of nitrous oxide. Thus, as nitrous oxide flows into the flow channel 80, the pressure of the nitrous oxide acts to move the valve member 102 out of the hole 98. Movement of the valve member 102 is resisted as discussed in greater detail below.

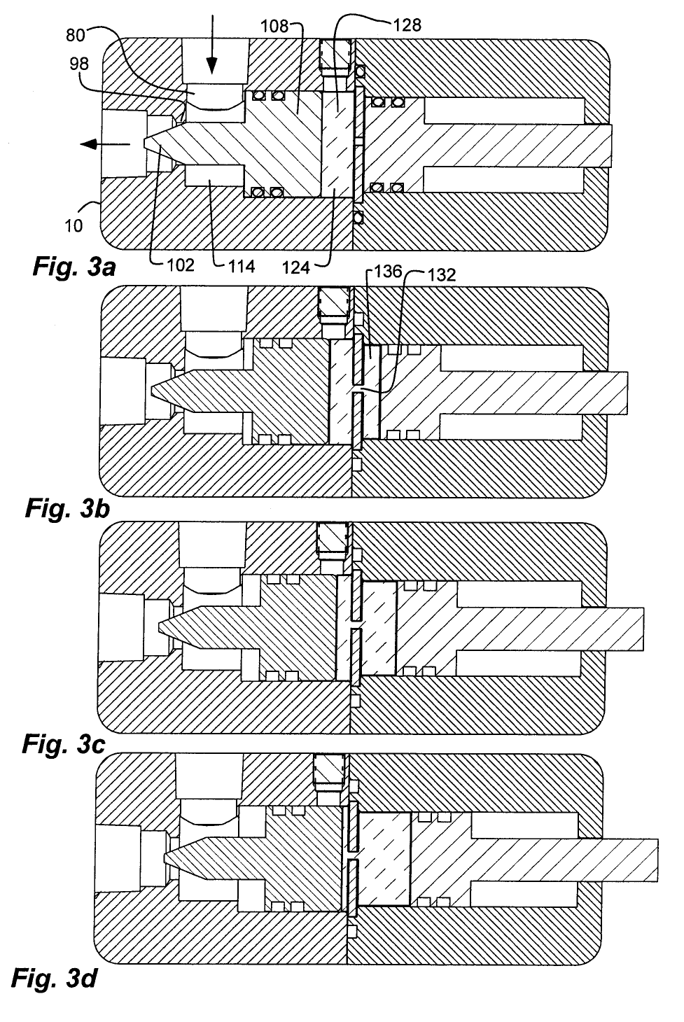

The valve member 102 can include, or can be part of, a resistance piston 108 movably disposed in a resistance cylinder 114 in the body 90, or in the body half 90a. For example, the resistance cylinder 114 can be formed by machining a bore in the body half 90a, and can be aligned with the hole 98 and the outlet 94. Similarly, the valve member 102 and the resistance piston 108 can be aligned with the hole 98 and the outlet 94. The resistance piston 108 can be in fluid communication with the flow channel 80 so that the pressure of the flow of nitrous oxide acts on the piston to move the valve member 102. For example, the resistance cylinder 114 can extend to the flow channel 80. The resistance piston 108 and resistance cylinder 114 form a resistor side 120 of a fluid reservoir 124 on a side of the piston opposite the flow channel and valve member. The fluid reservoir 124 is filled with a fluid that can be an incompressible fluid, such as hydraulic fluid 128 (FIG. 3a). An orifice 132 can be formed in the fluid reservoir 124 through which the fluid is displaceable as the piston moves. In operation, the pressure of the nitrous oxide in the flow channel 80 acts to push the piston 108 to reduce the volume of the resistor side 120 of the reservoir 124, thus pushing the fluid 128 through the orifice 132. The passage or displacement of fluid through the orifice acts to slow and/or resist the movement of the piston and the valve member, thus slowing and/or resisting the enlargement of the hole 98. The piston 108 and valve member 102 progressively displace, and the hole 98 progressively enlarges, as the fluid 128 passes or displaces through the orifice 132; thus progressively increasing the flow of nitrous oxide.

The fluid reservoir 124 can be a dual chamber reservoir and can further include an accumulator side 136 disposed on the opposite side of the orifice 132 from the resistor side 120. The fluid 128 accumulates in the accumulator side 136 of the reservoir as it displaces through the orifice. The accumulator side 136 can be formed by an accumulator piston 142 movable in an accumulator cylinder 146. The accumulator piston 142 can move to increase the volume of the accumulator side 136 as the fluid passes through the reservoir into the accumulator side. The accumulator side 146 can be formed by machining a bore into the second half 90b of the body.

The orifice 132 can be formed in a disc 154 that is disposed between the resistance cylinder 114 and the accumulator cylinder 146, and between the resistance side 120 and the accumulator side 136 of the reservoir. The disc 154 can be held between the halves 90a and 90b of the body 90. A round cavity can be formed in one or both halves to receive the disc and the disc can have a diameter or size greater than a diameter of the cylinders 114 and 146.

One or more discs with different sizes or numbers or orifices can be provided which can be selectively disposed in the body to provide the desired performance. As discussed above, the two halves 90a and 90b of the body 90 can be held together by bolts. Thus, the two halves can be separated and the desired disc can be placed in the body. Although a single disc is shown in the drawings, it will be appreciated that multiple different discs with different orifice configurations can be provided. In addition, although a single orifice is shown, it will be appreciated that one or more orifices can be provided. The orifice can be sized to determine the amount of time in which the full flow of nitrous oxide is achieved. For example, the time period can be between approximately 1 to 5 seconds.

A spring 162 or other biasing member can be disposed against the accumulator piston 142. The biasing member can assist in slowing the flow of nitrous oxide by providing resistance to the displacement of the fluid and/or can push against the accumulator piston to displace the fluid back to the resistor side of the reservoir after the pressure of the nitrous oxide is released.

The accumulator piston 142 can have a rod 168 that extends through a bore 172 in the body 90 or second half 90b of the body to allow the accumulator piston and/or device to be manually reset. A hydraulic fluid bore and plug can extend through the body or first half thereof to allow the fluid to enter or be drained from the reservoir.

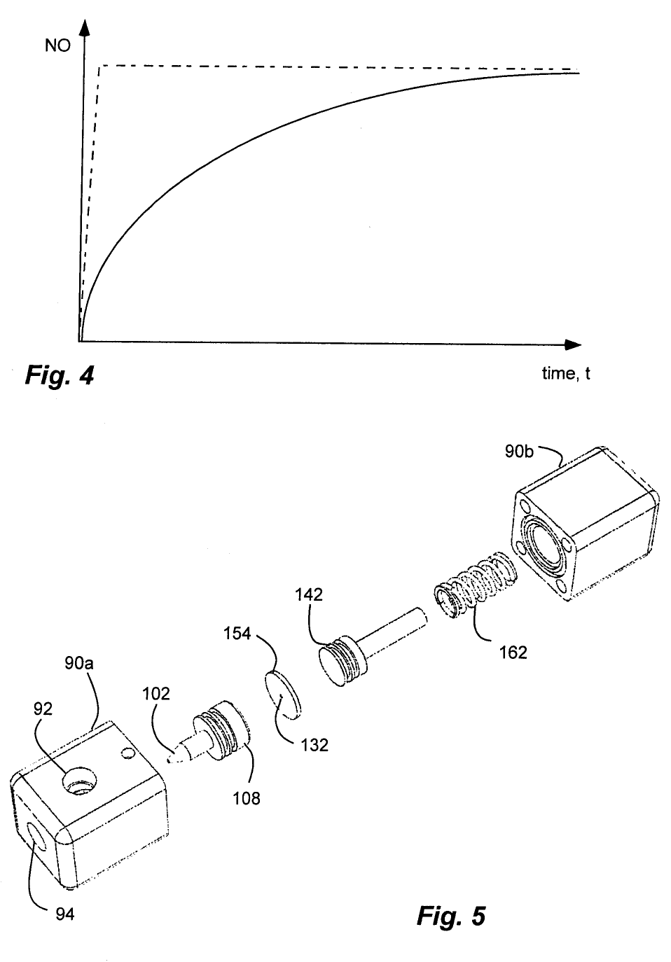

Referring to FIGS. 3a-4, the operation of the device is shown. FIGS. 3a-3d show the progression of device from a closed configuration, or more restricted position, in FIG. 3a, to progressively more open positions in FIGS. 3b-3d. It will be appreciated that FIGS. 3b-3d are discrete representations of a continuous progression of numerous positions as the pistons slide and the fluid displaces. In addition, it can be seen that the hole 98 or portion of the channel increases in size to allow more nitrous oxide to flow. It will be appreciated that the configuration shown in FIG. 3a and described as a closed configuration can also be partially open so that the device need not start in a completely closed configuration, only a more restricted position with respect to subsequent positions.

Referring to FIG. 4, the flow of nitrous oxide is shown schematically with respect to time with a solid line for the present device, versus a dashed line without the present device. Without the present device, the full effect of the nitrous oxide is essentially immediately delivered to the engine with the resulting strain and torque on the engine, transmission and/or power train, as shown by the dashed line. With the present invention, the flow of nitrous oxide is more gradually introduced to the engine, as shown by the solid line.

The fluid displaceable through the orifice is one example of a resisting means for resisting movement of the valve member 102 and enlargement of the portion or hole 98 of the flow channel 98. The resisting means can further include the resistance side 120 of the fluid reservoir formed by the resistance cylinder 124 and the resistance piston 108; the accumulator side 136 of the fluid reservoir formed by the accumulator cylinder 146 and accumulator piston 142; the disc 154; and/or the spring 162. Further examples of resisting means can include a diaphragm displacing a fluid through an orifice; biasing elements such as one or more springs; compressible or incompressible fluids; etc.

The valve member 102 and the hole 98, along with the fluid displaceable through the orifice, is one example of means for initially reducing the flow of nitrous oxide and progressively increasing the flow of nitrous oxide from a reduced amount to a greater amount over a time period. As described above, the time period can be between approximately 1 to 5 seconds. Such means can further include the resistance side 120 of the fluid reservoir formed by the resistance cylinder 124 and the resistance piston 108; the accumulator side 136 of the fluid reservoir formed by the accumulator cylinder 146 and accumulator piston 142; the disc 154; and/or the spring 162. Further examples of such means can include different valve member and hole configurations.

More specifically, while illustrative exemplary embodiments of the invention have been described herein, the present invention is not limited to these embodiments, but includes any and all embodiments having modifications, omissions, combinations (e.g., of aspects across various embodiments), adaptations and/or alterations as would be appreciated by those in the art based on the foregoing detailed description. The limitations in the claims are to be interpreted broadly based on the language employed in the claims and not limited to examples described in the foregoing detailed description or during the prosecution of the application, which examples are to be construed as non-exclusive. For example, in the present disclosure, the term “preferably” is non-exclusive where it is intended to mean “preferably, but not limited to.” Any steps recited in any method or process claims may be executed in any order and are not limited to the order presented in the claims. Means-plus-function or step-plus-function limitations will only be employed where for a specific claim limitation all of the following conditions are present in that limitation: a) “means for” or “step for” is expressly recited; and b) a corresponding function is expressly recited. The structure, material or acts that support the means-plus function are expressly recited in the description herein. Accordingly, the scope of the invention should be determined solely by the appended claims and their legal equivalents, rather than by the descriptions and examples given above.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

1. A progressive nitrous oxide controller device, comprising:
a) a nitrous oxide flow channel disposable between a nitrous oxide source and an engine and through which a flow of nitrous oxide is flowable;
b) a valve member movable with respect to the flow channel by pressure of the flow of nitrous oxide to enlarge a portion of the flow channel to increase the flow of nitrous oxide through the flow channel; and
c) resisting means operatively coupled to the valve member for resisting movement of the valve member and enlargement of the portion of the flow channel.

2. A device in accordance with claim 1, wherein the valve member has:
i) an initial restricted position corresponding to a reduced size of the portion of the flow channel configured to initially restrict the flow of nitrous oxide through the flow channel; and
ii) a plurality of subsequent less restricted positions corresponding to progressively enlarged sizes of the portion of the flow channel configured to progressively increase the flow of nitrous oxide through the flow channel, with the pressure of the flow of nitrous oxide causing the valve member to progress from the initial restricted position through the plurality of subsequent less restricted positions while the resisting means resists movement of the valve member.

3. A device in accordance with claim 1, further comprising:
a) a nitrous oxide source coupled to the nitrous oxide flow channel; and
b) a nitrous oxide valve operatively coupled between the nitrous oxide supply and the flow channel.

4. A device in accordance with claim 1, wherein the resisting means further comprises:
a fluid reservoir including an orifice and configured to receive fluid displaceable through the orifice.

5. A device in accordance with claim 4, wherein the reservoir further includes:
a dual chamber reservoir including a resistor side separated from an accumulator side by the orifice, the resistor side operatively coupled to the valve.

6. A device in accordance with claim 1, further comprising:
a) a body with the nitrous oxide flow channel disposed therein and extending between a nitrous oxide inlet and a nitrous oxide outlet; and
b) the valve member and the reservoir disposed in the body.

7. A device in accordance with claim 6, further comprising:
a) a resistance cylinder in the body;
b) a resistance piston movably disposed in the resistance cylinder;
c) the resistance cylinder and the resistance piston defining a resistor side of the reservoir;
d) the valve member operatively coupled to the resistance piston; and
e) the resistance piston in fluid communication with the flow channel such that the pressure of the flow of nitrous oxide acts to move the resistance piston and thus the valve member.

8. A device in accordance with claim 7, further comprising:
a) an accumulator cylinder in the body;
b) an accumulator piston movably disposed in the accumulator cylinder;
c) the accumulator cylinder and the accumulator piston defining an accumulator side of the reservoir; and
d) the accumulator side of the reservoir separated from the resistance side by the orifice.

9. A device in accordance with claim 8, further comprising:
a disc disposed between the resistance cylinder and the accumulator cylinder, and between the resistance side of the reservoir and the accumulator side of the reservoir, and having the orifice therein.

10. A device in accordance with claim 9, wherein the body further comprises:
a pair of body halves coupled together with the resistance cylinder in one body half and the accumulator reservoir in the other body half; and
the disc secured between the pair of body halves.

11. A progressive nitrous oxide controller device, comprising:
a) a body with a nitrous oxide channel extending between a nitrous oxide inlet and a nitrous oxide outlet, the nitrous oxide channel configured to receive a flow of nitrous oxide;
b) a nitrous oxide valve member movably disposed in the body with respect to the nitrous oxide channel to enlarge and reduce a portion of the nitrous oxide channel to respectively increase and decrease the flow of nitrous oxide through the channel;
c) a resistance piston coupled to the nitrous oxide valve member and movably disposed in the body and configured to move under pressure from the flow of nitrous oxide to enlarge the portion of the nitrous oxide channel and increase the flow of nitrous oxide;
d) a resistance cylinder in the body with the resistance piston movably disposed therein;
e) an incompressible fluid disposed in the resistance cylinder; and
f) an orifice associated with the resistance cylinder through which the incompressible fluid can pass, the resistance piston acting to force the incompressible fluid through the orifice.

12. A device in accordance with claim 11, wherein the valve member has:
i) an initial restricted position corresponding to a reduced size of the portion of the flow channel configured to initially restrict the flow of nitrous oxide through the flow channel; and
ii) a plurality of subsequent less restricted positions corresponding to progressively enlarged sized of the portion of the flow channel configured to progressively increase the flow of nitrous oxide through the flow channel, with the pressure of the flow of nitrous oxide causing the valve member to progress from the initial restricted position through the plurality of subsequent less restricted positions while the resisting means resists movement of the valve member.

13. A device in accordance with claim 1 1, further comprising:
a) a nitrous oxide source coupled to the nitrous oxide flow channel; and
b) a nitrous oxide valve operatively coupled between the nitrous oxide supply and the flow channel.

14. A device in accordance with claim 11, further comprising:
a) an accumulator cylinder in the body;
b) an accumulator piston movably disposed in the accumulator cylinder;
c) the accumulator cylinder separated from the resistance cylinder by the orifice.

15. A device in accordance with claim 14, further comprising:
a disc disposed between the resistance cylinder and the accumulator cylinder, and having the orifice therein.

16. A progressive nitrous oxide system for an engine, the system comprising:
a) a nitrous oxide supply configured to supply a flow of nitrous oxide;
b) a nitrous oxide valve operatively coupled to the nitrous oxide supply;
c) a progressive nitrous oxide controller device operatively coupled to the nitrous oxide valve and comprising:
i) a body with a nitrous oxide channel extending between a nitrous oxide inlet and a nitrous oxide outlet, the nitrous oxide inlet operatively coupled to the nitrous oxide valve;
ii) a valve member movable with respect to the flow channel by pressure of the flow of nitrous oxide to enlarge a portion of the flow channel to increase the flow of nitrous oxide through the flow channel;
iii) resisting means operatively coupled to the valve member for resisting movement of the valve member and enlargement of the portion of the flow channel;
iv) the valve member having: a) an initial restricted position corresponding to a reduced size of the portion of the flow channel configured to initially restrict the flow of nitrous oxide through the flow channel; and b) a plurality of subsequent less restricted positions corresponding to progressively enlarged sized of the portion of the flow channel configured to progressively increase the flow of nitrous oxide through the flow channel, with the pressure of the flow of nitrous oxide causing the valve member to progress from the initial restricted position through the plurality of subsequent less restricted positions while the resisting means resists movement of the valve member.

17. A system in accordance with claim 16, wherein the resisting means further comprises:
a fluid reservoir including an orifice and configured to receive fluid displaceable through the orifice.

18. A device in accordance with claim 16, further comprising:
a) a body with the nitrous oxide flow channel disposed therein and extending between a nitrous oxide inlet and a nitrous oxide outlet; and
b) the valve member and the reservoir disposed in the body.

19. A device in accordance with claim 18, further comprising:
a) a resistance cylinder in the body;
b) a resistance piston movably disposed in the resistance cylinder;
c) the resistance cylinder and the resistance piston defining a resistor side of the reservoir;
d) the valve member operatively coupled to the resistance piston;
e) the resistance piston in fluid communication with the flow channel such that the pressure of the flow of nitrous oxide acts to move the resistance piston and thus the valve member;
f) an accumulator cylinder in the body;
g) an accumulator piston movably disposed in the accumulator cylinder;
h) the accumulator cylinder and the accumulator piston defining an accumulator side of the reservoir; and
i) the accumulator side of the reservoir separated from the resistance side by the orifice.

20. A device in accordance with claim 19, further comprising:
a disc disposed between the resistance cylinder and the accumulator cylinder, and between the resistance side of the reservoir and the accumulator side of the reservoir, and having the orifice therein.

21. A progressive nitrous oxide system for an engine, the system comprising:
a) a nitrous oxide supply configured to supply a flow of nitrous oxide;
b) a nitrous oxide valve operatively coupled to the nitrous oxide supply configured to open and close to start and stop the flow of nitrous oxide;
c) a nitrous oxide nozzle operatively coupled to the nitrous oxide valve and configured to supply the flow of nitrous oxide to the engine; and
d) means operatively coupled between the valve and the nozzle for initially reducing the flow of nitrous oxide and progressively increasing the flow of nitrous oxide from a reduced amount to a greater amount over a time period of between approximately 1 to 5 seconds.
